(19) United States
(12) Patent Application Publication
(10) Pub. No.: US 2011/0057395 A1
(43) Pub. Date: Mar. 10, 2011

(54) SEAL ELEMENT

(75) Inventors: Lee Mercer, Aberdeen (GB); Stewart Christie, ABERDEEN (GB)

(73) Assignee: PETROWELL LTD., ABERDEEN (GB)

(21) Appl. No.: 12/743,397

(22) PCT Filed: Nov. 19, 2008
(86) PCT No.: PCT/GB2008/003883

§ 371 Date: Nov. 18, 2010

(30) Foreign Application Priority Data
Nov. 19, 2007 (GB) PCT/GB2007/004372

(51) Int. Cl. F16J 15/02; E21B 33/126

(52) U.S. Cl. 277/314; 277/607; 277/324; 277/602

(57) ABSTRACT

A seal element (120, 126) for sealing a conduit is described. The seal element comprises a frusto conical portion (28) and a first lip (30) extending from an external edge of the frusto conical portion, the lip being adapted to be pivoted into engagement with a conduit surface. In a described embodiment, two seal elements are provided on a plug (10) for sealing a conduit (16), the seal elements facing in opposite directions to seal from above and below.

### FIELD OF THE INVENTION

The present invention relates to seal elements, particularly to seal elements used in the oil and gas industry.

### BACKGROUND TO THE INVENTION

Conventionally well bores and apparatus associated with wellbores have been sealed with plugs and packers and the like. Plugs, for example, have three basic parts: an anchoring system, a seal element and a setting system.

The first stage in setting a conventional plug is anchoring the plug in the wellbore. Anchoring systems for conventional wellhead plugs use a set of locking dogs, which engage a recessed profile in the wellbore or tree, or use a set of slips which “bite” the casing to hold the plug in place.

The seal element is then set using a linear action setting mechanism to create a linear displacement to deform the seal element. The force required to create the seal is then locked in using a linear locking mechanism. In safety critical wellbore applications, for example sub sea trees, the seal is generally a metal-to-metal seal formed by swaging a metal ring element into the bore or onto a no-go shoulder.

To provide a seal capable of withstanding well pressures, the required setting force needs to be as high as the maximum force generated by the well pressure.

In recent years a number of high pressure, high temperature, high flow rate wells have been completed which have highlighted shortcomings in conventional designs of seal elements. For example, swaged seal elements can dislodge when exposed to the high pressure, temperature and vibration cycles of these wells, and the jarring action used to set the seal element can damage the seal element or the conduit or apparatus to be sealed.

A further disadvantage of conventional seal elements is that the expansion achievable from, for example, a metal seal element may not be sufficient to permit the apparatus incorporating the seal element to be run-into the wellbore with adequate clearance between the apparatus and the wellbore to prevent a build-up of pressure in front of the apparatus, resisting the placement of the apparatus. This can be a particular problem when a number of, for example, packers are to be located in series in a conduit, as a hydraulic lock can be formed between adjacent packers.

Furthermore, in cases where there is inadequate clearance, the metal seal element may engage the wellbore as the apparatus is run-in causing damage to the wellbore or to the seal element. If the seal element is damaged, this can result in an imperfect seal being formed by the seal element when the seal is set in its desired location.

In some instances, there is no clearance between the seal element and the conduit to be sealed and the seal element requires to be stabbed in which complicates runnig procedures and positional control.

### SUMMARY OF THE INVENTION

According to a first aspect of the present invention there is provided a seal element for sealing a conduit, the seal element comprising:

a frusto conical portion; and

a first lip extending from an external edge of the frusto conical portion;

wherein the first lip is adapted to be pivoted outwardly into engagement with a conduit surface. In one embodiment, being able to pivot the seal element into engagement with a conduit surface, permits an apparatus utilising the seal element to be run-into a bore with adequate clearance between the conduit wall and the seal element to prevent the build up of pressure or to prevent damage to either the seal element or the wellbore surface, which may otherwise be caused by engagement during the run-in.

Preferably, the seal element is, in use, pivoted into engagement with the conduit surface by a setting force.

Preferably, the application of the setting force moves the seal element from a run-in configuration to a set configuration.

Preferably, in use in the set configuration, the frusto-conical portion is biased towards the run-in configuration.

Preferably, in use in the set configuration, the first lip is biased towards a conduit wall.

Preferably, the frusto conical portion is arranged, in use, to be biased against the direction of the setting force.

Preferably, in use, the first lip is biased against a resistance applied by engagement with the conduit wall.

Preferably, in use, the setting force bends at least a portion of the seal element from the run-in configuration to the set configuration.

Most preferably, the seal element is bent within its elastic limit. This ensures when the setting force is removed, the seal element moves from the set configuration towards the run-in configuration.

Preferably, the seal element bends around a living hinge between the frusto conical portion and the first lip.

Preferably, in moving from the run-in configuration to the set configuration, an outer edge of the frusto conical portion is displaced radially outwards. By this it is meant the movement of the outer edge includes a radial component which is outwards.

Preferably, upon removal of the setting force, the outer edge of the frusto conical portion moves radially inwardly. By this it is meant the movement of the outer edge includes a radial component which is inwards. Preferably, for at least part of the radially inward movement of the outer edge of the frusto conical portion the first lip is adapted to remain in contact with a conduit surface.

In one embodiment, upon removal of the setting force, the first lip moves radially outwardly.

Preferably, upon removal of the setting force, in moving from the set configuration to the run-in configuration, the angle between the frusto conical portion and the first lip increases.

Preferably, upon removal of the setting force, the radially outward movement of the first lip is less than the radially inward movement of the frusto conical portion. Such an arrangement ensures that the first lip disengages from the conduit when the setting force is removed from the seal element and the seal element recovers from the set configuration towards the run-in configuration.

Preferably, the setting force is applied to the frusto conical portion.

Most preferably, there is no setting force applied to the first lip. Applying the setting force to the frusto conical portion ensures that the seal formed between the first lip and the conduit surface is a contact seal and, as such, minimal contact stress is caused to the conduit surface by engagement between the sealing surface of the lip and conduit itself. In one embodiment, the contact stress is controlled via the living hinge between the first lip and the frusto conical portion. The hinge provides the sealing energy. In this embodiment, the sealing contact is created in situ, providing seal performance and protection for the sealing surfaces

Preferably, in use, the first lip is energised into engagement with the conduit wall by an applied pressure, such as a downhole or well pressure.

Preferably, the first lip comprises a ridge for engaging a conduit wall.

Preferably, the ridge, in use, forms a seal with a conduit wall.

Preferably, the ridge has a constant radius profile.

Preferably, the seal element is a metal seal element.

Most preferably, the seal element is steel.

In one embodiment the steel is a noble steel.

Alternatively, the seal element may be a polymeric material.

The seal elements may be formed by pressing. Alternatively, they may be spun or machined or manufactured by any suitable method.

Preferably, the seal element is adapted to be formed in a stack with other seal elements.

Preferably, the seal element comprises a second lip extending from an internal edge of the frusto conical portion.

Preferably, the second lip extends in the same direction as the first lip.

Preferably, the second lip is adapted to engage a portion of an apparatus. The apparatus may be a plug, a packer, or any apparatus which is suitable for creating, or adapted to create, a seal in a conduit or requires a seal to be created in an conduit.

The apparatus portion may be an apparatus surface.

Preferably, the second lip is adapted to form a seal with a portion of an apparatus

Preferably, in use in the set configuration, the second lip is biased towards the apparatus surface.

Preferably, in use, the second lip is biased against a resistance applied by engagement with the apparatus surface.

Preferably, the seal element bends around a living hinge between the frusto conical portion and the second lip.

Preferably, for at least part of the radially inward movement of the outer edge of the frusto conical portion the second lip is adapted to remain in contact with the apparatus surface.

Preferably, upon removal of the setting force, in moving from the set configuration to the run-in configuration, the angle between the frusto conical portion and the second lip increases.

Preferably, there is no setting force applied to the second lip.

Preferably, in use, the second lip is energised into engagement with the apparatus surface by an applied pressure, such as a downhole or well pressure.

Preferably, during the setting of the seal element, the seal element, in use pivots around a contact point between the second lip and a plug surface.

Preferably, the second lip comprises a ridge for engaging the apparatus surface.

Preferably, the ridge, in use, forms the seal with the apparatus surface.

Preferably, the ridge has a constant radius profile.

In one embodiment the seal element is adapted to pivot about the second lip ridge.

The second lip ridge may slide with respect to the apparatus surface.

According to a second aspect of the present invention there is provided an apparatus for sealing a conduit, the apparatus comprising:

a body;

a setting device;

a seal element, the seal element comprising a frusto conical portion and a first lip extending from an edge of a frusto conical portion;

wherein relative movement of the setting device with respect of the body applies a setting force to the seal element, pivoting, in use, the first lip into engagement with a conduit surface.

In one embodiment the apparatus comprises a plurality of seal elements.

In this embodiment the seal elements may be arranged in a stack.

Alternatively or additionally, some of the seal elements may be facing the opposite direction to some other seal elements. Having the seal elements facing in the opposite directions can, in use, seal a conduit from pressure from above or below the apparatus.

Preferably, the seal element comprises a second lip adapted to engage a portion of the apparatus body.

Preferably, the setting device is moved axially with respect to the body.

Alternatively the setting device is pivoted with respect to the body.

According to a third aspect of the present invention there is provided a seal element for sealing a conduit comprising:

a frusto conical washer, the washer defining a lip extending from an external edge of the washer.

According to a fourth aspect of the present invention there is provided a seal element for sealing a conduit comprising a first portion biased away from forming a seal with the conduit and a second portion biased towards forming a seal with a conduit.

In one embodiment, a seal element according to the present invention can recover from a set configuration to a run-in configuration by removal of a setting force due to the first portion recovering a greater radial distance than the second portion.

According to a fifth aspect of the present invention there is provided a method of setting a plug and a conduit, the method comprising the steps of:

applying a setting force to a seal element having a frusto conical portion and a first lip extending from an external edge of the frusto conical portion; and

pivoting the first lip into engagement with the conduit surface.

Preferably, the step of pivoting the first lip into engagement with the conduit surface comprises pivoting the seal element about a second lip extending from an internal edge of the frusto conical portion.

Alternatively or additionally, the step of pivoting the first lip into engagement with the conduit surface comprises bending at least a portion of the seal element.

According to a sixth aspect of the present invention there is provided a seal element for sealing a conduit, the seal element comprising:

a frusto conical portion; and

a first lip extending from an external edge of the frusto conical portion;

wherein the first lip is adapted to be rotated into engagement with a conduit surface.

According to a seventh aspect of the present invention there is provided a seal element for sealing a conduit, the seal element comprising:

a frusto conical portion; and

a lip extending from an internal edge of the frusto conical portion;

wherein the lip is adapted to be pivoted into engagement with a surface.

It will be understood that features listed as being non-essential with respect to one aspect may be equally applicable to another aspect and have not been re-stated for brevity.

### BRIEF DESCRIPTION OF THE DRAWINGS

An embodiment of the present invention will, now be described with reference to the accompanying drawings in which

FIG. 1 is a section view of a plug in a run-in configuration, the plug having opposed seal elements according to an embodiment of the present invention;

FIG. 2 is a section view through the plug of FIG. 1 in a set configuration;

FIG. 3 is a close up of part of the plug of FIG. 1 in a run-in configuration;

FIG. 4 is a close up of part of the plug of FIG. 1 in the set configuration;

FIG. 5 is a section view through one of the seal elements of FIG. 1; and

FIG. 6 is a close up of detail ‘A’ of FIG. 5.

### DETAILED DESCRIPTION OF THE DRAWINGS

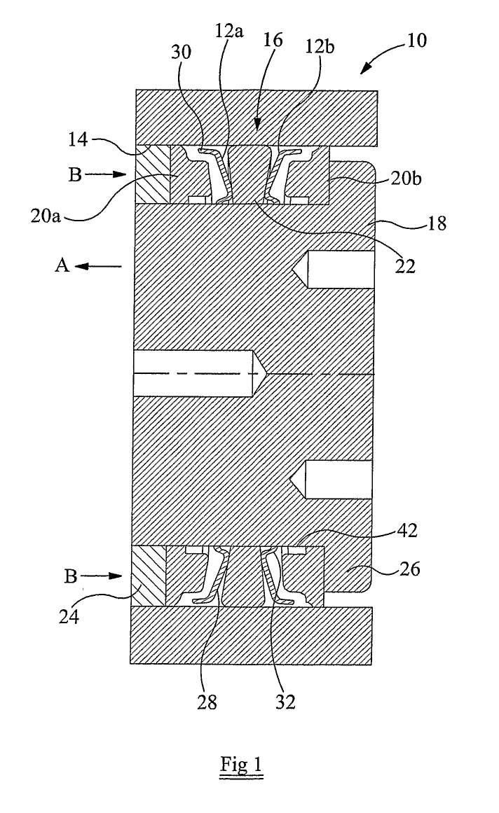

FIG. 1 shows a section view of a plug, generally indicated by reference numeral 10, in a run-in configuration according to an embodiment of the present invention. The plug 10 has opposed seal elements 12a, 12b for forming a seal with the internal surface 14 of a conduit 16. In this run-in configuration, there is clearance between the seal elements 12 and the conduit surface 14 preventing damage to the conduit surface 14 and the seal elements 12 as the plug 10 is run into position.

The plug 10 further comprises a mandrel 18, a first seal setting ring 20a, a second seal setting ring 20b, a seal support ring 22 and a housing 24.

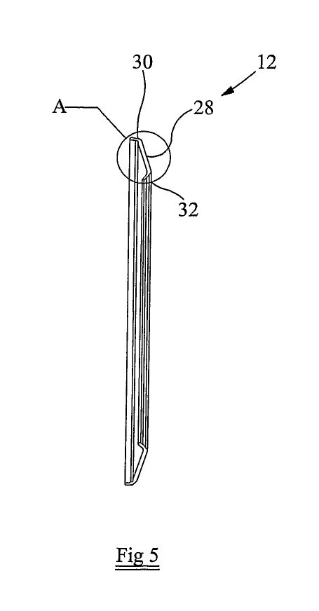

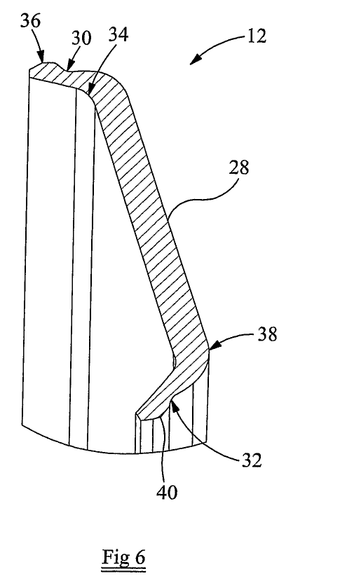

Referring to FIG. 1, FIG. 5, and particularly to FIG. 6, the seal elements 12 comprise a frusto conical portion 28, a first lip 30 and a second lip 32. The seal elements 12 are made from pressed from steel. The first lip 30 extends from an external edge 34 of the frusto conical portion 28. The first lip 30 also includes a constant radius ridge 36 for forming a contact seal with the conduit internal surface 14. The second lip 32 extends in approximately the same axial direction as the first lip 30 from an internal edge 38 of the frusto conical portion 28. The second lip 32 also comprises a constant radius ridge 40 for forming a contact seal with a mandrel surface 42 (FIG. 1).

To set the seal elements 12 and create a seal, a pull force is applied to the mandrel 18 in the direction of arrow A (FIG. 1) and a push force is applied to the housing 24 in the direction of arrow B. As relative movement is permitted between the mandrel 18 and the housing 24, the housing 24 acts on the first seal setting ring 20a which also moves in the direction of arrow B towards the first seal element 12a. A mandrel flange 26 moves in the direction of arrow A and acts on the second seal setting ring 20b which in turn engages and acts on the second seal element 12b. The seal elements 12 are prevented from axial movement by engagement with the seal support ring 22. The housing 24 applies a setting force to the first seal element 12a and the mandrel 14 applies a setting force to the second seal element 12b.

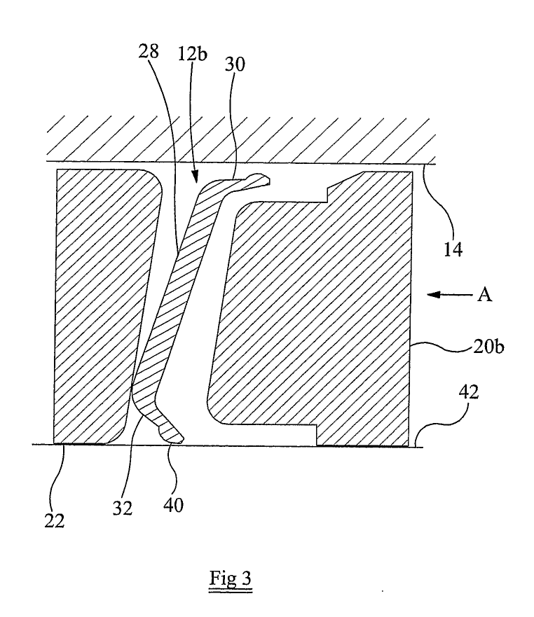

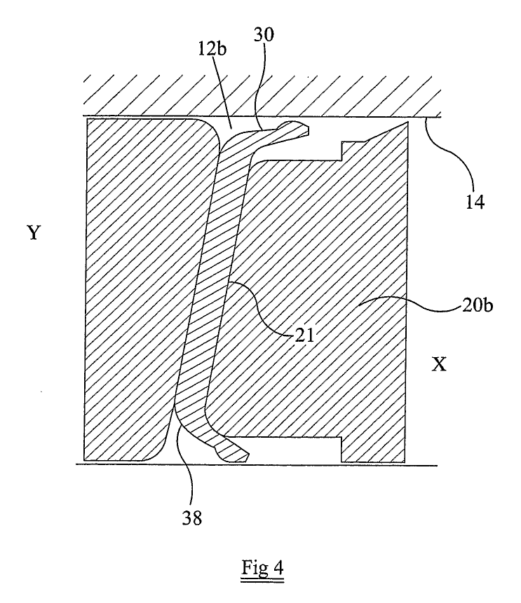

The setting procedure is shown more clearly in FIGS. 3 and 4. FIG. 3 IS a section view of part of the plug of FIG. 1 showing the second seal setting ring 20b, the seal support ring 22 and the seal element 12b. The seal element 12b is in the run-in configuration and is displaced from the conduit surface 14. The seal element inner lip 32 is in contact with the mandrel surface 42 and particularly the contact is made by the second lip ridge 40. As the second seal setting ring 20b moves in the direction of arrow A into contact with the frusto conical portion 28, the seal element 12b pivots about the second lip ridge 40 and particularly the first lip 30 pivots into engagement with the conduit surface 14.

Referring now to FIG. 4, a section view of part of the plug of FIG. 1 showing the seal element 12b in the set configuration. The seal element 12b has pivoted about the second lip ridge 40 and has bent at the internal edge 38 of the frusto conical portion 28; the interface between the frusto conical portion 28 and the second lip 38, such that a contact seal is formed between the first lip 30 and the conduit surface 14. Once the lip 30 has engaged the conduit surface 14, continued application of the setting force to the seal element 12b by the seal setting ring 20b results in the seal element 12b bending about the interface between the frusto conical portion 28 and the lip 30 at the frusto conical portion external edge 34. The deformation of the seal element 12 by the setting force is elastic deformation so that the seal element 12 can recover to the run-in configuration upon removal of the setting force.

The contact seal which is formed between the lip 30 and the conduit surface 14 will cause minimal damage to the conduit surface 14 because the setting force applied by the seal setting ring 20b (created by the pull of the mandrel 18 in the direction of arrow A and the push applied to the housing 24 in the direction of arrow B in FIG. 1) acts primarily on the frusto conical portion 28 and does not act on the first lip 30.

The seal element 12b is arranged so that if the pressure downhole (indicated by “X” on FIG. 4) is greater than the uphole pressure (indicated by “Y”) then the seal will be forced into a tighter engagement with conduit surface 14.

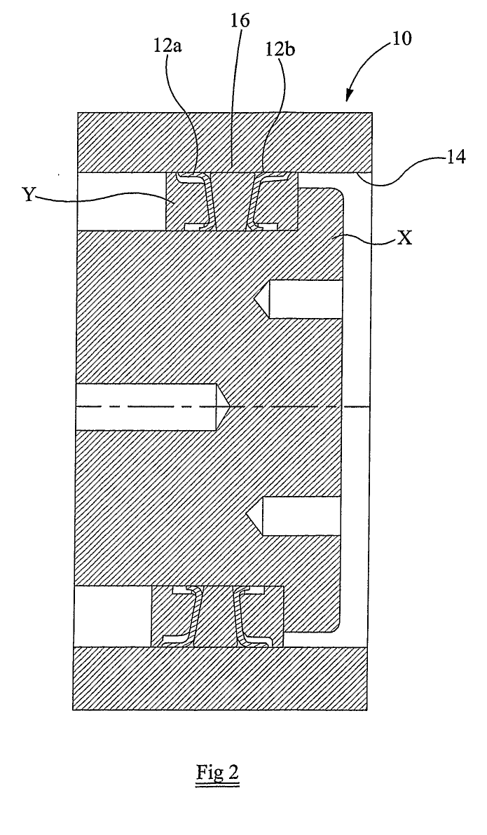

Reference is now made to FIG. 2 which shows the plug 10 in the set configuration with the seal elements 12 fully engaged with the conduit surface 14. Two seal elements 12a, 12b are provided to create a seal in both directions. As was discussed with reference to FIG. 4 in the previous paragraph, the second seal element 12b will be forced into tighter engagement if the pressure downhole “X” is greater than the pressure uphole “Y” and similarly the first seal element 12a will be forced into tighter engagement if the pressure uphole “Y” is greater than the pressure downhole “X”.

When the setting force is removed by moving the mandrel 18 in the direction of arrow B and the housing 24 in the direction of arrow A, the seal elements 12 can recover to the run-in configuration, permitting the plug to be recovered without damaging the conduit surface 14. It will be noted however that although the recovery of the seal elements 12 overall is away from the conduit surface 14, the recovery of the lip 30 is towards the conduit surface 14.

Various modifications and improvements may be made to the described embodiment without departing from the scope of the invention. For example although only two seal elements are used in the described embodiment, and the seal elements form individual seals sealing in opposite directions, each of these individual seal elements could be replaced by a stack of seals. Furthermore although the seal elements are described in conjunction with a plug, any suitable apparatus such as a plug or gasket could incorporate the seal elements. Additionally, the angle between the lips and the frusto conical portion could be increased or decrease to accommodate differing seal glands. Similarly the lip length could vary from that shown.

1. A seal element for sealing a conduit, the seal element comprising: a frusto conical portion; and a first lip extending from an external edge of the frusto conical portion; wherein the first lip is adapted to be pivoted outwardly into engagement with a conduit surface.

2. The seal element of claim 1, wherein the seal element is, in use, pivoted into engagement with the conduit surface by a setting force, the setting force moving the seal element from a run-in configuration to a set configuration.

3. (canceled)

4. The seal element of claim 2, wherein, in use, in the set configuration, the frusto-conical portion is biased towards the run-in configuration.

5. The seal element of claim 2, wherein, in use, in the set configuration, the first lip is biased towards a conduit wall.

6. The seal element of claim 2, wherein the frusto conical portion is arranged, in use, to be biased against the direction of the setting force.

7. The seal element of claim 2, wherein in use, the first lip is biased against a resistance applied by engagement with the conduit wall.

8. The seal element of claim 2, wherein in use, the setting force bends at least a portion of the seal element from the run-in configuration to the set configuration.

9. (canceled)

10. (canceled)

11. The seal element of claim 2, wherein in moving from the run-in to the set configuration, an outer edge of the frusto-conical portion is displaced radially outwards and upon removal of the setting force, an outer edge of the frusto conical portion moves radially inwardly.

12. (canceled)

13. The seal element of claim 2, wherein for at least part of the radially inward movement of the outer edge of the frusto conical portion, the first lip is adapted to remain in contact with a conduit surface.

14. The seal element of claim 2, wherein upon removal of the setting force, in moving from the set configuration to the run-in configuration, the angle between the frusto conical portion and the first lip increases.

15. The seal element of claim 2, wherein the setting force is applied to the frusto conical portion.

16. The seal element of claim 2, wherein there is no setting force applied to the first lip.

17. The seal element of claim 5, wherein in use, the first lip is energised into engagement with the conduit wall by an applied pressure.

18. The seal element of claim 1, wherein the first lip comprises a ridge for engaging a conduit wall.

19. (canceled)

20. (canceled)

21. The seal element of claim 1, wherein the seal element comprises a metal.

22. (canceled)

23. The seal element of claim 1, wherein the seal element comprises a polymeric material.

24. The seal element of claim 1, wherein the seal element is adapted to be formed in a stack with other seal elements.

25. The seal element of claim 1, wherein the seal element comprises a second lip extending from an internal edge of the frusto conical portion, the second lip extending in the same direction as the first lip.

26. (canceled)

27. The seal element of claim 25, wherein the second lip is adapted to engage and form a seal with an apparatus surface.

28. (canceled)

29. (canceled)

30. The seal element of claim 27, wherein, in use in the set configuration, the second lip is biased towards the apparatus surface.

31. The seal element of claim 30, wherein, in use, the second lip is biased against a resistance applied by engagement with the apparatus surface.

32. The seal element of claim 27, wherein during the setting of the seal element, the seal element pivots, in use, around a contact point between the second lip and the apparatus surface.

33. (canceled)

34. The seal element of claim 25, wherein, in use, the second lip is energised into engagement with the apparatus surface by an applied pressure, such as a downhole or well pressure.

35. The seal element of claim 25, wherein, the second lip comprises a ridge for engaging a plug surface.

36. (canceled)

37. (canceled)

38. The seal element of claim 35, wherein the seal element is adapted to pivot about the second lip ridge.

39. The seal element of claim 35, wherein the second lip ridge slides with respect to the apparatus surface.

40. An apparatus for sealing a conduit, the apparatus comprising: a body; a setting device; and a seal element, the seal element comprising a frusto conical portion and a first lip extending from an edge of said frusto conical portion; wherein relative movement of the setting device with respect of the body applies a setting force to the seal element, pivoting, in use, the first lip into engagement with a conduit surface.

41. The apparatus of claim 40, wherein the apparatus comprises a plurality of seal elements arranged in a stack.

42. (canceled)

43. The apparatus of claim 41, wherein some of the seal elements are facing the opposite direction to some other seal elements.

44. The apparatus of claim 40, wherein the seal element comprises a second lip adapted to engage the body.

45. The apparatus of claim 40, wherein the setting device is movable axially with respect to the body to set the/each seal element.

46. The apparatus of claim 40, wherein the setting device is pivoted with respect to the body.

47. (canceled)

48. A seal element for sealing a conduit comprising a first portion biased away from forming a seal with the conduit and a second portion biased towards forming a seal with the conduit.

49. A method of setting a plug and a conduit, the method comprising the steps of: applying a setting force to seal an element having a frusto conical portion and a first lip extending from an external edge of the frusto conical portion; and pivoting the first lip into engagement with a conduit surface.

50. The method of claim 49, wherein the step of pivoting the first lip into engagement with the conduit surface comprises pivoting the element about a second lip extending from an internal edge of the frusto conical portion.

51. The method of claim 49, wherein the step of pivoting the first lip into engagement with the conduit surface comprises bending at least one portion of the element.

52. (canceled)
